(19) United States
(12) Patent Application Publication
(10) Pub. No.: US 2010/0212057 A1
(43) Pub. Date: Aug. 26, 2010

(54) BUOYANT IMPACT-RESISTANT SUIT

(76) Inventor: JEREMIAH SAWYER SULLIVAN, San Diego, CA (US)

Correspondence Address: SHEPPARD, MULLIN, RICHTER & HAMPTON LLP, 12275 EL CAMINO REAL, SUITE 200, SAN DIEGO, CA, 92130, US

(21) Appl. No.: 12/714,091

(22) Filed: Feb. 26, 2010

Related U.S. Application Data
(60) Provisional application No. 61/155,872, filed on Feb. 26, 2009.

(51) Int. Cl. B64G 6/00; B63C 11/04; F41H 1/02

(52) U.S. Cl. 2/2.11; 2/2.15; 2/2.5

(57) ABSTRACT

The present invention provides an impact-resistant suit having a base layer of material dimensioned to fit over a body of a wearer, and at least one impact-resistant panel attached to the base layer, the impact-resistant panel being sized and positioned with respect to the base layer to protect a specific part of the body of the wearer from localized impacts. In some embodiments, the impact-resistant suit comprises a super buoyant wetsuit having an upper body portion that substantially resists crush-down at extreme pressures.

### RELATED APPLICATIONS

This application claims the benefit of the priority of U.S. Provisional Patent Application No. 61/155,872 filed on Feb. 26, 2009, the content of which is incorporated herein by reference in its entirety.

### TECHNICAL FIELD

The present invention relates generally to active wear clothing and protective garments, and more particularly, some embodiments relate to a buoyant, laceration-, abrasion-, and impact-resistant suit.

### DESCRIPTION OF THE RELATED ART

Most active wear clothing, fabrics, garments, and accessories are generally of minimal effectiveness and of limited comfort. Garments and accessories made of conventional materials that are touted as puncture, laceration, abrasion and/or impact resistant are nearly unwearable, or at least suffer from bulkiness, denseness, rigidity, and, most importantly, ineffectiveness.

Impact-resistant suits, such as shark-resistant suits that are worn by swimmers or divers to counter adverse effects of a shark bite, are conventionally very cumbersome and heavy. Further, the materials used are usually some form of metal, which can sink in water.

Newer types of materials are proving to be resistant to limited types of impacts, lacerations, abrasions or other conditions, but are individually unable to address more than one, or at most several, adverse conditions or threats, while still able to be provided in a form that is suitable for wearing.

### BRIEF SUMMARY OF EMBODIMENTS OF THE INVENTION

The present invention is directed toward a buoyant, impact-resistant suit. In some embodiments of the invention, the suit may be embodied as a wetsuit, such as for use in scuba-diving, surfing, kite boarding, rescue diving, water-based military or police exercises, etc. The impact-resistance of the suit makes the suit resistant to lacerations, abrasions, cuts, piercings, and other adverse conditions, while still providing a suit that is buoyant, flexible and comfortable to the wearer.

In various embodiments of the invention, the buoyant, impact-resistant suit is made from high strength, protective fibers, fabrics and materials, as well as methods for making the impact-resistant suit. In particular, the fabrics may be formed of high-strength fibers that can be incorporated with other materials to produce comfortable garments and accessories that are resistant to laceration, abrasion, impact and puncture. The impact-resistant suit may be employed for (i) marine use including water sports and activities such as scuba diving, surfing, kite boarding, rescue divers, and (ii) military use for impact-resistant clothing, upholstery and accessories.

In one implementation, the impact-resistant suit may comprise a wetsuit, in which various specific locations of the wetsuit can include different combinations of protective fibers, fabrics and materials. In another implementation, the impact-resistant suit may comprise a uniform such as a military battle dress uniform (BDU). In yet another implementation, the impact-resistant suit may be foamed into specific items of clothing such as shirts, pants, or undergarments.

One embodiment of the invention provides an impact-resistant suit having a base layer of material dimensioned to fit over a body of a wearer, and at least one impact-resistant panel attached to the base layer, the impact-resistant panel being sized and positioned with respect to the base layer to protect a specific part of the body of the wearer from localized impacts. In some embodiments, the impact-resistant suit comprises a super buoyant wetsuit having an upper body portion that substantially resists crush-down at extreme pressures.

Other features and aspects of the invention will become apparent from the following detailed description, taken in conjunction with the accompanying drawings, which illustrate, by way of example, the features in accordance with embodiments of the invention. The summary is not intended to limit the scope of the invention, which is defined solely by the claims attached hereto.

### BRIEF DESCRIPTION OF THE DRAWINGS

The present invention, in accordance with one or more various embodiments, is described in detail with reference to the following figures. The drawings are provided for purposes of illustration only and merely depict typical or example embodiments of the invention. These drawings are provided to facilitate the reader's understanding of the invention and shall not be considered limiting of the breadth, scope, or applicability of the invention. It should be noted that for clarity and ease of illustration these drawings are not necessarily made to scale.

FIG. 1 illustrates the general form of an impact-resistant suit in accordance with an embodiment of the invention.

FIG. 2 illustrates an impact-resistant suit comprising a wet suit, head gear and gloves, in accordance with the principles of the invention.

FIG. 3 depicts a Rochelle type double knit weave of approximately 400 denier, which forms the base material of an impact-resistant suit in accordance with an embodiment of the invention.

FIG. 4 depicts a shaped and specially-formed impact-resistant material that can be molded or fused to another base impact-resistant material for localized and specific impact resistance, in accordance with the principles of the invention.

FIG. 5 is a close-up view of the shaped and specially-formed impact-resistant material for being molded or fused to a base impact-resistant material, in accordance with the principles of the invention.

The figures are not intended to be exhaustive or to limit the invention to the precise form disclosed. It should be understood that the invention can be practiced with modification and alteration, and that the invention be limited only by the claims and the equivalents thereof.

### DETAILED DESCRIPTION OF THE EMBODIMENTS OF THE INVENTION

The present invention is directed toward an impact-resistant suit. In one embodiment, the suit is formed of a base layer of material, such as neoprene or other water-accommodative material. In particular, one or more impact-resistant materials, in the form of fabric or protective fibers, are incorporated onto or with the base layer of material, to produce a buoyant, impact-resistant suit. The one or more impact-resistant materials can be incorporated by attachment to the base layer of material as shaped and molded panels, for example by being molded to the base layer of material, or fused to the base layer of material. The impact-resistant materials may be made from high strength, protective fibers (hereinafter referred to generally as “protective fibers”), having any of a number of desirable properties. Methods for manufacturing s an impact-resistant suit are also provided.

In a particular implementation, one or more fibers from a selected group of fibers can be knitted or woven into a fabric, combined with other fibers or materials, and applied or otherwise used as a protective component of an impact-resistant suit. The protective component provides a wearer of the impact-resistant suit with great resistance to impacts such as the bite of a shark or in the form of a bullet. In the case of a shark bite, the impact-resistant suit generally protects the wearer from potential laceration, abrasion, impact and puncture injuries. Example impact-resistant suits may include without limitation, wetsuits, drysuits, uniforms, vests, flightsuits, pullovers, rash guards, swim skin, jackets, coveralls, and other garments.

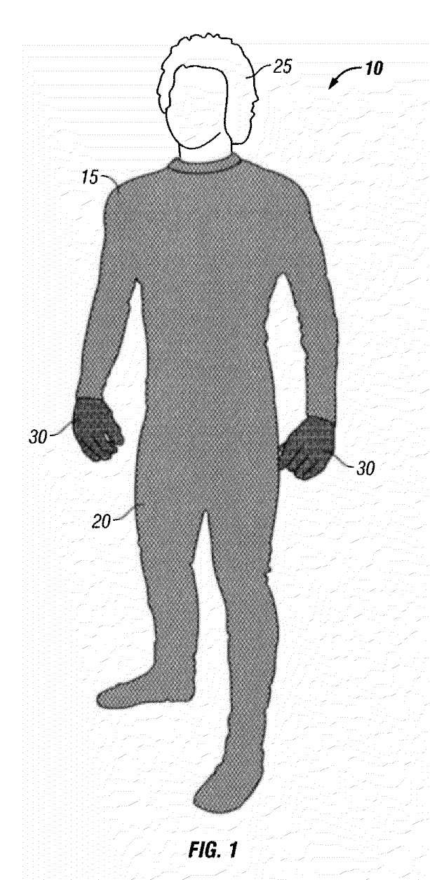

FIG. 1 illustrates the general form of an impact-resistant suit 10 in accordance with an embodiment of the invention. The impact-resistant suit 10 includes an upper body portion 15 and a lower body portion 20 that covers the wearer 25 from the neck down to the toes. A pair of protective gloves 30 may also be worn by the user. The impact-resistant suit 10 is generally abrasion-resistant, impact-resistant, laceration-resistant, and thermal-resistant to keep the wearer sufficiently warm or cool. As set forth herein, the suit 10 includes one or more impact-resistant materials that are specifically positioned and incorporated with the base layer of material of the suit 10, thereby inhibiting or eliminating the threat of puncture, cutting, or piercing by objects such as teeth, knives, spears, thorns, coral, moving projectiles, or other sharp points or edges. Additionally, because the impact-resistant suit 10 is sleek and fits close to the wearer's body, it limits drag in the water. For example, the suit 10 may include a smooth outline bonded down to crushed neoprene for a snug and streamlined fit.

In one implementation, the impact-resistant suit 10 comprises a super buoyant wetsuit having an upper body portion 15 that substantially resists crush-down at extreme pressures. In other words, the buoyancy and thickness of the upper body portion 15 is substantially maintained at very high pressures. The super buoyant wetsuit is suitable for use by kayakers, water skiers, fishermen, and other users. In another implementation, the impact-resistant suit 10 comprises a super buoyant drysuit. In a further implementation, the impact-resistant suit 10 comprises a non-super buoyant wetsuit that is suitable for divers. In yet another implementation, the impact-resistant suit 10 comprises a non-super buoyant drysuit that is suitable for use as a space suit. Such an implementation may further include a neck ring and vacuum-tight zippers such that the suit is airtight.

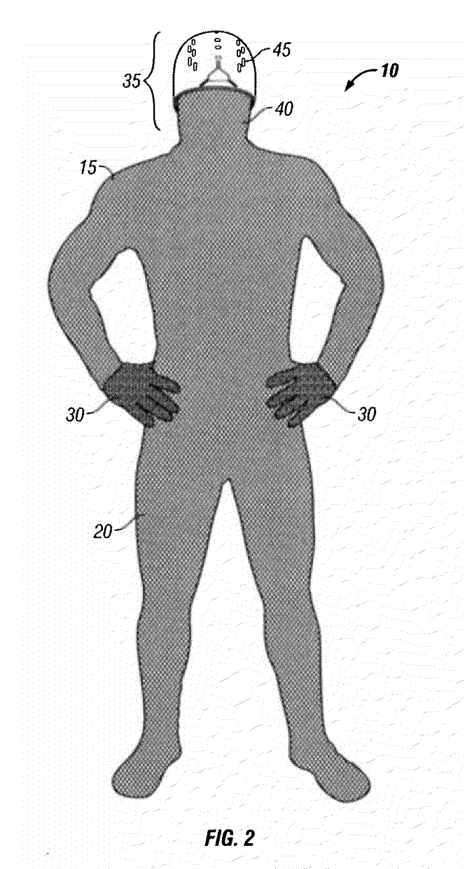

FIG. 2 illustrates an impact-resistant suit comprising impact-resistant suit 10 having upper body portion 15 and lower body portion 20, gloves 30 and head gear 35, in accordance with another embodiment of the invention. The head gear 35 includes a substantially flexible inner shell 40 and an impact-resistant outer shell 45 or helmet portion 45.

The impact-resistant suit 10 generally includes a base layer of material. In some embodiments of the invention, the one or more impact-resistant materials are applied to only one side, i.e. the outer side, of the base layer of material. In other embodiments, the one or more impact-resistant materials are applied to both sides of the base layer. This application of impact-resistant materials to both sides of the base layer of material can be generally within the same shape and area.

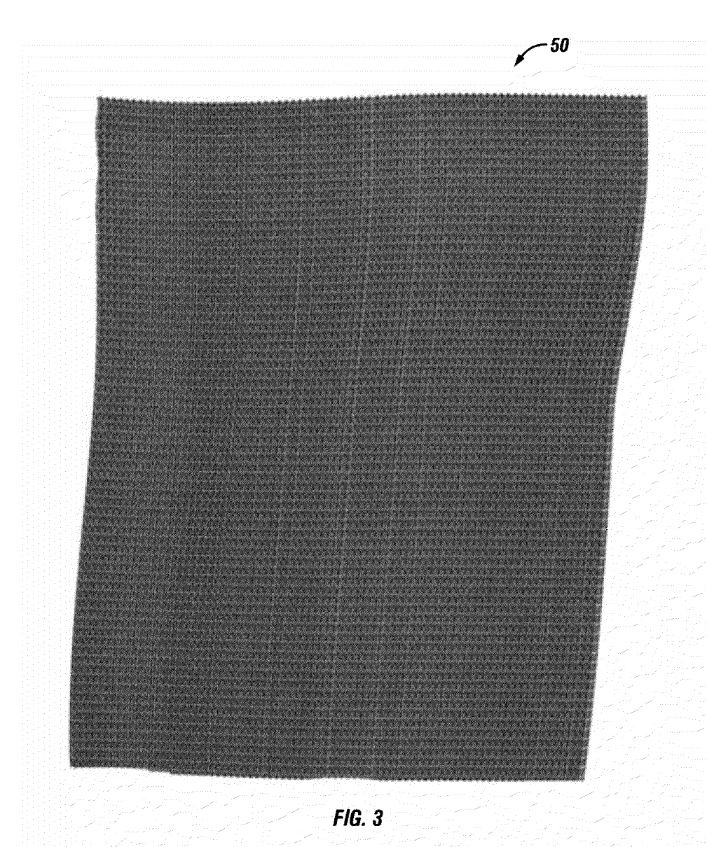

The one or more impact-resistant materials can be made of a variety of flexible, yet sturdy impact-resistant textiles, fibers, cloth or material. For example, an impact-resistant material can be made of liquid crystal polymer fiber, such as Vectran™ or other super strong protective fiber such as described herein. The fiber can be woven in into an interlocking knitted fabric, such as a Rochelle-type knit fabric, in the range of 200 to 600 denier weave. FIG. 3 depicts a Rochelle-type double knit weave 50 of approximately 400 denier, which forms the base material of the impact-resistant suit 10 in accordance with an embodiment of the invention. The knitted fabric can be layered one on top of another, at various offset angles from zero to 180 degrees. The Rochelle-type double knit weave 50 is merely exemplary and many other types of fabrics and/or weaves (such as described herein) may be employed without departing from the scope of the invention.

In another embodiment, the knitted fabric can be quilted into multiple connected or semi-connected layers as a quilted material. The latter, “soft connection” assembly can serve to trap, inhibit, or defeat the movement of sharp points or edges through the impact-resistant material toward the wearer of the suit 10. The quilted material can be cut into panels of various patterns or shapes for application to the base layer, with small gaps therebetween to allow continued flexibility of the base layer and suit in general. The quilted material can also be patterned with various raised or dimpled edges, or patterned with a replicate of human musculature, to give the wearer an appearance of athletic fitness.

The one or more impact-resistant materials can be loosely connected together by stitching, molding, thermal bonding, gluing, or layering, and can include a soft flotation material or interstitial material such as foam, gel, or other thin buoyant or flexible materials.

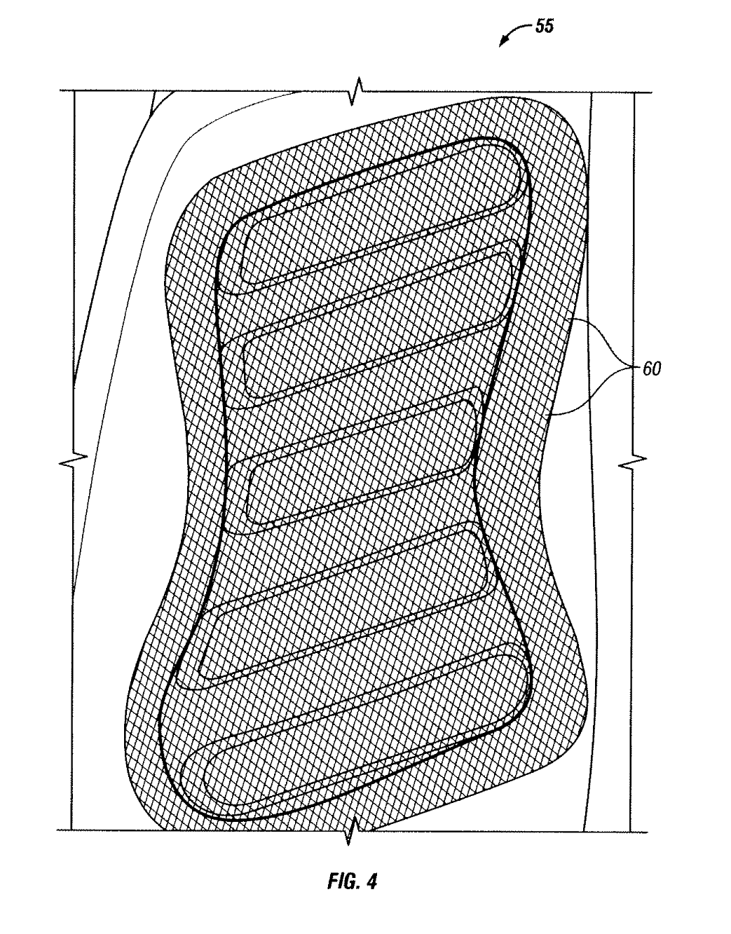

FIG. 4 depicts a shaped and specially-formed impact-resistant panel 55 that can be molded or fused to a base impact-resistant material for localized and specific impact resistance, in accordance with the principles of the invention. Specifically, the impact-resistant panel 55 may be bonded to the outer surface of the base material to protect both the suit material and the suit wearer from damage/injury. By way of example, the impact-resistant panel 55 may be positioned to protect the wearer's knee, elbow, thigh or chest. The impact-resistant panel 55 includes projections/ribs 60 to provide stiffness. The panel 55 may comprise a Rochelle type double knit weave, or other type of fabric and/or weave described herein.

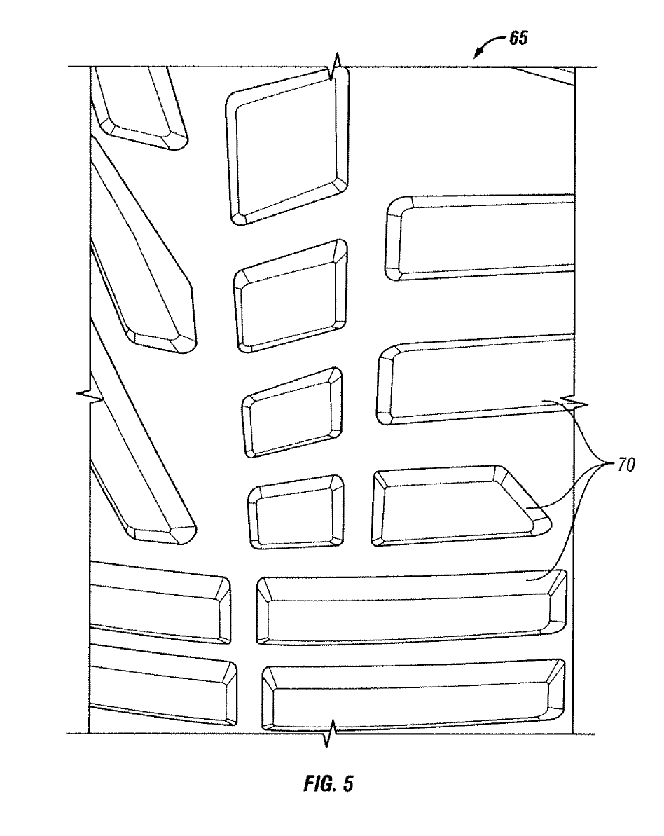

FIG. 5 is a close-up view of a shaped and specially-formed impact-resistant panel 65 for being molded or fused to a base impact-resistant material, in accordance with the principles of the invention. The impact-resistant panel 65 includes projections/ribs 70 to provide stiffness. The panel 65 may be bonded to the outer surface of the base material to protect both the suit material and the suit wearer from damage/injury. For example, the impact-resistant panel 65 may be positioned to protect the wearer's knee, elbow, thigh or chest. The panel 65 may comprise any suitable metal or plastic including, but not limited to: titanium; steel; carbon fiber; and fiberglass. In operation, the panel projections 70 act as stiffening agents that may also provide impact resistance. In some embodiments, the projections are filled or stuffed with polystyrene, closed/open cell PV foam, or a polycarbonate void such that the panel also acts as a buoyancy agent.

### Protective Fibers

According to some embodiments of the invention, the protective fiber used to form impact-resistant suit 10 may comprise a meta-aramid fiber, such as Nomex™. Meta-aramid fibers are dry spun and generally exhibit: (i) high tenacity (tensile stress when expressed as force per unit linear density of the unstrained specimen), (ii) high modulus (the ratio of change in stress—in force per unit linear density or force per unit area of the original specimen—to change in strain—i.e. percentage contraction or elongation of the specimen—following removal of crimp from the specimen being tested), and (iii) high heat resistance. Additionally, meta-aramid fibers provide heat and flame resistance, anti-static behavior, and resistance to industrial oils, solvents, oxidation, and most chemicals. In some implementations, a meta-aramid fiber is formed into a fabric and used as a primary barrier in garments and accessories. Such a meta-aramid fiber may be combined with other fibers and materials to achieve desired effects in accordance with various embodiments of the invention.

According to further embodiments of the invention, the protective fiber comprises a para-aramid fiber, such as Kevlar™ or Twaron™. Para-aramid fibers are dry-wet or wet spun, and exhibit very high tenacity, high modulus and high heat resistance. Other embodiments may include a protective fiber in the form of a liquid crystal polymer fiber such as Vectran™. Liquid crystal polymer fibers are dry spun, and exhibit high strength, high modulus, and high heat resistance, as well as high resistance to moisture and chemicals. Further, liquid crystal polymer fibers generally retain these properties in hostile environments. Other example fibers that can be used as a protective fiber include, but are not limited to, polyphenylenebenzimidazole (PBI), polybenzoxazole (PBO), and polyethylene.

According to various exemplary impact-resistant suits set forth herein, each protective fiber is made in 100-2500 denier filament, with an exemplary weight of about 200-600 denier. Each impact-resistant suit comprises one or more protective fibers that are woven, knitted or otherwise formed into a fabric (hereinafter “protective fabric”). In implementations where two or more protective fibers are employed, each protective fiber can have the same denier. Alternatively, protective fibers of different deniers can be used. By way of example, two or more protective fibers can be woven or knitted into separate protective fabrics and combined in layers or patterns of layers. One or more layers of protective fabrics can be bonded, glued, stitched, or fused together, or bonded, glued, stitched or fused to a base garment or accessory material such as neoprene, cotton, nylon, or the like. A selected layer of fabric may be adjusted to various biases with the other layers. Flipping selected layers in the stack can be desirable to achieve certain desired properties. Additionally, two or more of the materials described herein for making a protective fiber may be blended together to form a yarn, which is then turned into a knit or weave. Such materials include, but are not limited to, Vectran™ (liquid crystal polymer), Nomex™ (meta-aramid), Kevlar™ (para-aramid), Twaron™ (para-aramid), nylon, olefin, s-glass, elastic, spandex, polyethylene, diamond tough nylon, Zylon™ (thermoset polyurethane synthetic polymer material), Technora™ (aromatic copolyamid), Spectra™ (extended-chain polyethylene) and metallic fibers.

### Knit Types/Weave Types

According to various embodiments of the invention, protective fabrics are made of protective fibers knitted into a fabric. In further embodiments, protective fibers may be woven, braided, or otherwise formed into a fabric. In knitted configurations, a protective fabric is formed of a circular-knit or flat-knit jersey stitch, in which the loops of plain stitching intermesh in only one direction. A jersey-style protective fabric can be formed to be stretchable in two directions. In other implementations, a protective fabric is formed of a terry knit, i.e. having uncut loops of protective fiber on one or both sides. A protective fabric can be ribbed, crimped, flat, double knitted, or ring spun. In specific implementations, a protective fiber may be produced in 2″-30″ tubular form, or 4″-60″ flat form. Such a protective fiber may have a produced weight of approximately 0.5-1.5 lbs. per square yard.

### Fabrics/Composition

The protective fabric described herein can be formed to exhibit specific properties, such as being stretchable in four-ways or two-ways, or alternatively to be stiff and inelastic. In some implementations, a protective fiber can be interwoven or integrated with elastic or other stretchable material for added flexibility, or with one or more other protective fibers to produce a protective fabric with specific combinations of properties such as strength and flame resistance.

### Products

As discussed herein, impact-resistant suits and accessories may include, but are not limited to, wetsuits, drysuits, uniforms, vests, flightsuits, pullovers, rash guards, jackets, coveralls, gear bags, pouches, pockets, harnesses, webgear, hats, helmets, headgear, shoes, skate shoes, socks, booties, cuffs, armbands, gloves, tents, armor carriers, belts, bags, covers, rope and other items.

In accordance with another specific implementation, protective fibers and protective fabrics can be used for a water-oriented application. In such an application, the protective fibers and fabrics can be integrated with a wetsuit, with a drysuit, or employed in a garment worn over or under a wetsuit or drysuit. In addition to the insulation and/or water-impermeable qualities, the protective fibers and fabrics provide laceration, abrasion, impact and puncture resistance.

### Method of Manufacture

According to some embodiments, method of manufacturing an impact-resistant suit comprises the steps of: (i) forming an insulator base layer; (ii) forming a protective layer and attaching the layer to a body side of the insulator base layer; and (iii) forming one or more protective components such as impact-resistant panels, wherein each protective component includes at least one protective component layer; and (iv) attaching the one or more protective components to selected areas of an outer side of the insulator base layer. Forming the protective layers (i.e., protective layer and protective component layer(s)) may comprise forming a protective fiber, cutting the protective fiber, and knitting or weaving the fibers to form the protective fabric. At least one of the protective layers may be formed using a blend of two or more materials selected from the group consisting of, liquid crystal polymer, meta-aramid, para-aramid, nylon, olefin, s-glass, elastic, spandex, polyethylene, diamond tough nylon, polyphenylenebenzimidazole, polybenzoxazole, thermoset polyurethane synthetic polymer material, aromatic copolyamid, and extended-chain polyethylene. Each of the protective layers may include fibers having a tensile strength of at least 3 GPa and a modulus of at least 70 GPa.

The impact-resistant suit may be formed by knitting or weaving the fibers into an interlocking knitted fabric having a weight of 200-600 denier. Suitable knits and weaves include without limitation, V-bed, terry, jersey, rib knit, double knit interlock, Rochelle, and other knits and weaves. Additionally, the protective garment may feature a combination of knits and weaves. The material is then quilted into multiple softly or semi-connected layers. This semi-loose assembly of softly or semi-connected layers is useful in ‘trapping’ and defeating sharp edged objects like sharks teeth, bullets and shrapnel. The quilted material is then cut into pattern shapes or panels and incorporated into or onto the garment in a manner such as those mentioned herein. The layers of protective material are loosely fused together by stitching, molding or layering in with a soft flotation material such as foam, gel or other thin buoyant material. The protective quilted material can be a simple pattern of shapes with small gaps between the panels to allow flexibility of the substrate material. Alternatively, the protective quilted material can be patterned to replicate the appearance of human musculature, again with gaps between the sections (for flexibility of the substrate material), giving the wearer of the suit a very fit athletic appearance. For wetsuit embodiments, the suit is sleek and fits close to the body to limit drag in the water. In particular, the layers of protective material are loosely fused together by stitching, molding or layering in with a soft flotation material such as foam, gel or other thin buoyant material.

The protective fabrics described herein can be assembled by a cut and sew operation. Cutting can be achieved by mechanical operations such as using knife blades. In some embodiments, heat cutting may be employed whereby a cutting blade is heated to a temperature above the zero-strength temperature of the fiber.

The resultant fabric or impact-resistant suit made from one or more protective fibers can include texture or patterns. The fabric or suit may also be manufactured to exhibit other features such as ultraviolet protection, dynamic toughness, good flex fatigue. In addition, the fabric or suit may be easy to splice, cut or bond with other fabrics or materials.

Although the invention is described above in terms of various exemplary embodiments and implementations, it should be understood that the various features, aspects and functionality described in one or more of the individual embodiments are not limited in their applicability to the particular embodiment with which they are described, but instead can be applied, alone or in various combinations, to one or more of the other embodiments of the invention, whether or not such embodiments are described and whether or not such features are presented as being a part of a described embodiment. Thus, the breadth and scope of the present invention should not be limited by any of the above-described exemplary embodiments.

Terms and phrases used in this document, and variations thereof, unless otherwise expressly stated, should be construed as open ended as opposed to limiting. As examples of the foregoing: the term “including” should be read as meaning “including, without limitation” or the like; the term “example” is used to provide exemplary instances of the item in discussion, not an exhaustive or limiting list thereof; the terms “a” or “an” should be read as meaning “at least one,” “one or more” or the like; and adjectives such as “conventional,” “traditional,” “normal,” “standard,” “known” and terms of similar meaning should not be construed as limiting the item described to a given time period or to an item available as of a given time, but instead should be read to encompass conventional, traditional, normal, or standard technologies that may be available or known now or at any time in the future. Likewise, where this document refers to technologies that would be apparent or known to one of ordinary skill in the art, such technologies encompass those apparent or known to the skilled artisan now or at any time in the future.

The presence of broadening words and phrases such as “one or more,” “at least,” “but not limited to” or other like phrases in some instances shall not be read to mean that the narrower case is intended or required in instances where such broadening phrases may be absent. Additionally, the various embodiments set forth herein are described in terms of exemplary block diagrams, flow charts and other illustrations. As will become apparent to one of ordinary skill in the art after reading this document, the illustrated embodiments and their various alternatives can be implemented without confinement to the illustrated examples. These illustrations and their accompanying description should not be construed as mandating a particular architecture or configuration.

1. An apparatus comprising:
an impact-resistant suit having a base layer of material dimensioned to fit over a body of a wearer; and
at least one impact-resistant panel attached to the base layer, the impact-resistant panel being sized and positioned with respect to the base layer to protect a specific part of the body of the wearer from localized impacts.

2. The apparatus of claim 1, wherein the impact-resistant suit comprises a super buoyant wetsuit having an upper body portion that substantially resists crush-down at extreme pressures.

3. The apparatus of claim 2, wherein the upper body portion includes a predetermined buoyancy and thickness, and wherein the predetermined buoyancy and thickness are substantially maintained at very high pressures.

4. The apparatus of claim 1, wherein the impact-resistant suit comprises a super buoyant drysuit having an upper body portion that substantially resists crush-down at extreme pressures.

5. The apparatus of claim 1, wherein the impact-resistant suit comprises a non-super buoyant wetsuit that is suitable for divers.

6. The apparatus of claim 1, wherein the impact-resistant suit comprises a non-super buoyant drysuit that is suitable for use as a space suit.

7. The apparatus of claim 6, further comprising a neck ring and vacuum-tight zippers such that the suit is airtight.

8. The apparatus of claim 1, wherein the impact-resistant panel is bonded to an outer surface of the base layer to protect both the base layer and the body of the wearer.

9. The apparatus of claim 1, wherein, the impact-resistant panel is positioned to protect the wearer's knee, elbow, thigh or chest.

10. The apparatus of claim 1, wherein the impact-resistant panel includes projections to provide stiffness.

11. The apparatus of claim 10, wherein the projections are filled or stuffed with polystyrene, closed/open cell PV foam, or a polycarbonate void such that the panel also acts as a buoyancy agent.

12. The apparatus of claim 1, wherein the impact-resistant panel comprises metal or plastic.

13. The apparatus of claim 12, wherein the impact-resistant panel comprises titanium, steel, carbon fiber, or fiberglass.

14. The apparatus of claim 1, wherein the base layer comprises neoprene or other porous open cell or closed cell flexible foam rubber.

15. An apparatus comprising:
an impact-resistant suit having a base layer of material dimensioned to fit over a body of a wearer; and
at least one impact-resistant panel attached to the base layer, the impact-resistant panel being sized and positioned with respect to the base layer to protect a specific part of the body of the wearer from localized impacts;
wherein the impact-resistant suit comprises a super buoyant wetsuit having an upper body portion that substantially resists crush-down at extreme pressures;
wherein the impact-resistant panel is bonded to an outer surface of the base layer to protect both the base layer and the body of the wearer.

16. The apparatus of claim 15, wherein, the impact-resistant panel is positioned to protect the wearer's knee, elbow, thigh or chest.

17. The apparatus of claim 15, wherein the impact-resistant panel includes projections to provide stiffness.

18. The apparatus of claim 17, wherein the projections are filled or stuffed with polystyrene, closed/open cell PV foam, or a polycarbonate void such that the panel also acts as a buoyancy agent.

19. The apparatus of claim 15, wherein the impact-resistant panel comprises metal or plastic.

20. The apparatus of claim 19, wherein the impact-resistant panel comprises titanium, steel, carbon fiber, or fiberglass.

21. The apparatus of claim 15, wherein the base layer comprises neoprene or other porous open cell or closed cell flexible foam rubber.
